(19) United States
(12) Patent Application Publication
(10) Pub. No.: US 2008/0253603 A1
(43) Pub. Date: Oct. 16, 2008

(54) Hanging type wireless earphone for carrying digital music player

(75) Inventor: Kuan-Di Huang, Taoyuan County (TW)

Correspondence Address: BACON & THOMAS, PLLC, 625 SLATERS LANE, FOURTH FLOOR, ALEXANDRIA, VA, 22314-1176, US

(73) Assignees: Kuan-Di HUANG, Taoyuan County (TW); Su-Shan CHEN, Taoyuan County (TW)

(21) Appl. No.: 11/812,284

(22) Filed: Jun. 18, 2007

(30) Foreign Application Priority Data
Apr. 14, 2007 (TW) 096113172

(51) Int. Cl. H04R 5/033

(52) U.S. Cl. 381/374

(57) ABSTRACT

A hanging type wireless earphone for carrying a digital music player includes a pair of speaker bases and a hanging frame. The two speaker bases are respectively mounted on two ends of the hanging frame. When the hanging frame is worn on a user's head, the two speaker bases are respectively positioned and covered on the user's two ears. One of the two speaker bases is provided with a receiving space and a positioning element. The receiving space is used to receive a digital music player of any specification, such as an MP3 player. The positioning element is used to stably position the digital music player in the receiving space, so that the digital music player of any specification can be easily integrated into the hanging type wireless earphone and directly positioned on the user's head without using any necklace auxiliary.

### FIELD OF THE INVENTION

The present invention relates to a wireless earphone, and more particularly to a hanging type wireless earphone for carrying a digital music player.

### BACKGROUND OF THE INVENTION

Recently, the market of digital music players has been more and more expanded, well-known international manufacturers, such as Apple, Sony, and etc., respectively develop various newest products with newest music management softwares to satisfy consumers' needs for the purpose of maintaining and increasing their market share in the growing market of digital music players. For example, the so-called “iPod Nano”, the newest digital music player manufactured by Apple, is provided with a storage medium of a flash memory instead of a miniature hard disk used in the previous “iPod” digital music player. As a result, the thickness of the iPod Nano player is only 6.9 mm, and the weight thereof is only 42 g, so as to carry out the design purpose of miniaturization. Apple provides two types of the iPod Nano players with two different storage capacities of 4 GB and 2 GB, and the suggested retail prices thereof are respectively USD278 and USD218 in USA (i.e. between NTD7,500 and NTD5,900). On the other hand, in order to increase the market share, Sony has also developed five series products of the so-called “Walkman A” digital music players which further provide an intelligent function of song selection capable of automatically searching other songs with a tune similar to that of a presently played song in a shuffle mode. Furthermore, the intelligent function of song selection can also be used to search and play songs belonging an assigned tear range. Three of the five series products of the Walkman A players are respectively provided with a flash memory with three different storage capacities of 2 GB, 1 GB, and 512 Mb, and the suggested retail prices thereof are between JPY22,000 and JPY32,000 (i.e. between NTD5,900 and NTD8,600) in Japan.

Generally, a digital music player with a flash memory as a storage media only has a storage capacity smaller than that of a digital music player with a miniature hard disk as a storage media. However, the digital music player with the flash memory has several advantages, such as more compact volume, more convenient to carry, and easier to operate. Presently, related manufacturers generally develop digital music players with a flash memory as a storage medium mainly having a storage capacity between 256 Mb and 1 GB, and a suggested retail price between NTD1,000 and NTD6,000 in Taiwan. Therefore, the price of the digital music players with the flash memory as the storage medium is low enough to be accepted by most of general consumers, and also can provide enough storage capacity for satisfying the needs of the consumers. As a result, in the market of digital music players, the digital music players with the flash memory occupy a market share substantially greater than that of the digital music players with the miniature hard disk. In other words, the digital music players with the flash memory have become the most popular products in the market of digital music players.

However, no matter which type of the storage media, such as the flash memory or the miniature hard disk, the digital music players is equipped with a plug type earphone is generally provided along with the digital music player by the manufacturers as a standard auxiliary thereof. Generally, the plug type earphone has several advantages, such as more compact volume, more convenient to carry, and clearer voice, but also has several disadvantages. For example, because the plug type earphone is inevitably inserted into a user's ear deep to a position close to the ear drum, it is liable to discomfort or hurt the user's ear under a long-term operation. In addition, because the plug type earphone generates a relatively higher voice volume, the user's ear drum may be damaged and the user's hearing may be adversely affected. Recently, in order to solve the foregoing problems, most of ENT (ear-nose-throat) physicians suggest the users to select hanging type earphones, such as frame type earphones or hooking type earphones, for listening to the music played by the digital music player, so as to maintain the safety of the hearing and the health of the ear. However, referring now to FIG. 1, when a user 10 uses a traditional hanging type earphone 20 for listening to the music played by a traditional digital music player 30, the digital music player 30 is suspended on the user's neck by a necklace auxiliary 40 and an earphone connector 22 provided at one end of a signal cable 21 of the earphone 20 is connected to an earphone jack (not shown) of the digital music player 30. As a result, because the signal cable 21 and the necklace auxiliary 40 are suspended on the user's body 10 and easily get tugged during the user 10 moves, the signal cable 21 and the necklace auxiliary 40 may be subject to becoming entangled with each other or with an external object, or alternatively, impede the normal motion of the body, and in turn cause inconvenience to the user 10.

Thus, it is important for related manufacturers of digital music players and hanging type wireless earphones to improve and develop a hanging type wireless earphone for carrying a digital music player, and to integrate them into one unit, such that a user will be able to directly operate a control panel of the digital music player without any entanglement problems caused by the necklace auxiliary and signal cable for conveniently listening to analog voice signals played by the digital music player via the hanging type wireless earphone.

### SUMMARY OF THE INVENTION

It is therefore tried by the inventor to develop a hanging type wireless earphone for carrying a digital music player, and to integrate the hanging type wireless earphone and the digital music player into one unit, such that a user will be able to listen to voice signals played by the digital music player without any necklace auxiliary and signal cable, for the purpose of solving the problems existing in the conventional hanging type earphone that the signal cable and the necklace auxiliary may be easily entangled with each other or other external objects, resulting in impeding the normal motion of the user's body, as described above.

A primary object of the present invention is to provide a hanging type wireless earphone for carrying a digital music player, which comprises a pair of speaker bases and a hanging frame, wherein the two speaker bases are respectively mounted on two ends of the hanging frame; when the hanging frame is worn on a user's head, the two speaker bases are respectively positioned and covered on two ears of the user; one of the two speaker bases is provided with a receiving space and a positioning element, wherein the receiving space is used to receive a digital music player of any specification, such as an MP3 player, and the positioning element is used to stably position the digital music player in the receiving space, so that the digital music player of any specification can be easily integrated into the hanging type wireless earphone and directly positioned on the user's head without using any necklace auxiliary, for efficiently solving the problem that the traditional digital music player is suspended on the user's neck by a necklace auxiliary resulting in impeding the normal motion of the user's body and causing inconvenience to the user.

A secondary object of the present invention is to provide a hanging type wireless earphone for carrying a digital music player, wherein the receiving space has a periphery provided with an earphone connector which has a direction and a position adjustable in relation to the receiving space; the earphone connector can be electrically connected to an earphone jack of the digital music player, while the earphone connector is further connected to a pair of speakers in the two speaker bases via a pair of signal cables, so that the user can integrate the digital music player of any specification, such as an MP3 player, into the hanging type wireless earphone, and directly control a control panel of the digital music player for selecting voice files stored in the digital music player, while the digital music player generates analog voice signals which are respectively outputted to the two speakers via the earphone jack and the earphone connector for playing voice or music corresponding to the analog voice signals, in such a way that the user can enjoy listening to the voice or music by the hanging type wireless earphone without using an additional signal cable for being connected to the earphone jack of the digital music player, for the purpose of efficiently solving the problem that the traditional digital music player is connected to the hanging type wireless earphone via the signal cable suspended on the user's body resulting in impeding the normal motion of the user's body and causing the inconvenience of the user.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an operational view of a traditional digital music player equipped with a traditional hanging type earphone;

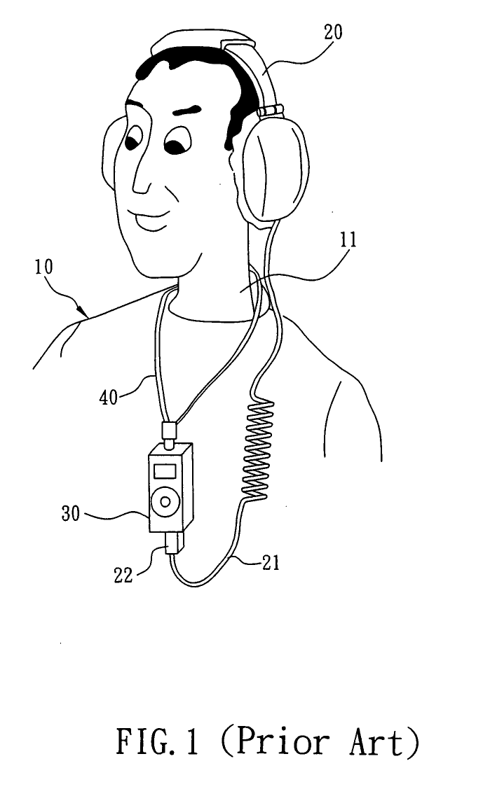

FIG. 2 is a perspective view of a hanging type wireless earphone for carrying a digital music player according to a preferred embodiment of the present invention;

FIG. 3 is a partially enlarged perspective view of the hanging type wireless earphone of FIG. 2 according to the preferred embodiment of the present invention; and

FIG. 4 is a partially enlarged view of a hanging type wireless earphone for carrying a digital music player according to another preferred embodiment of the present invention.

### DETAILED DESCRIPTION OF THE PREFERRED EMBODIMENTS

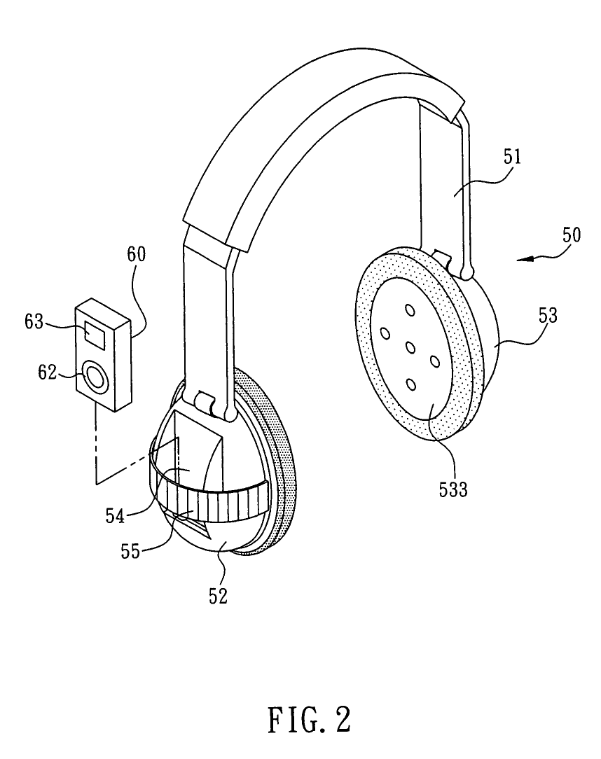

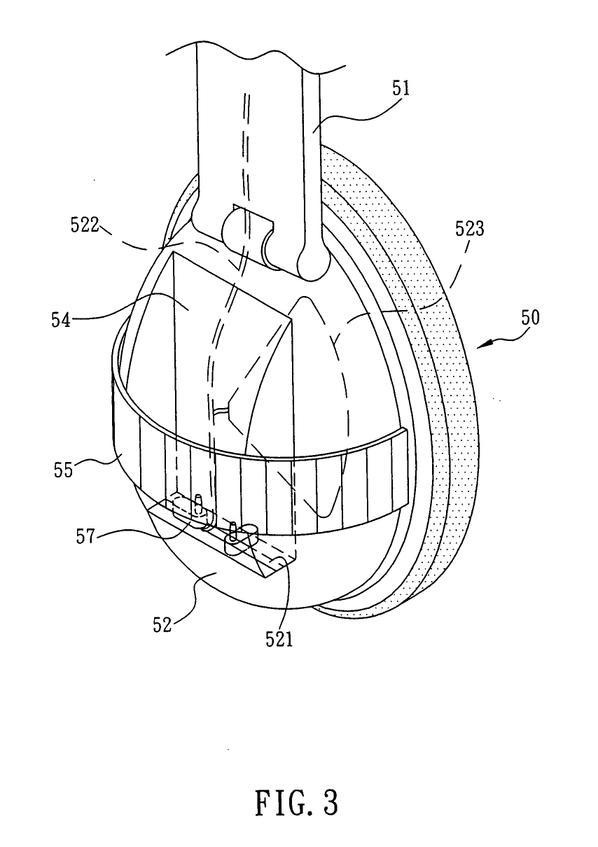

Referring now to FIG. 2, a hanging type wireless earphone for carrying a digital music player according to a preferred embodiment of the present invention is illustrated. As shown, the hanging type wireless earphone designated by numeral 50 comprises a hanging frame 51 and a pair of speaker bases 52, 53. In the preferred embodiment of the present invention as shown in FIG. 2, each of the two speaker bases 52, 53 is movably or fixedly mounted on either end of the hanging frame 51. When the hanging frame 51 is worn on a user's head, the two speaker bases 52, 53 can be positioned and covered on the user's two ears, so that the user's ears can hear voice generated by the two speaker bases 52, 53. In the preferred embodiment of the present invention as shown in FIG. 2, one of the two speaker bases 52, 53 (i.e. the speaker base 52) is provided with a receiving recess 54 and a positioning element 55. The receiving recess 54 has a dimension suitably used to receive a digital music player 60 of various specifications, such as an MP3 player. The positioning element 55 is mounted on a periphery of the receiving recess 54, and used to stably position the digital music player 60 in the receiving recess 54 after the digital music player 60 is received in the receiving recess 54. Preferably, the positioning element 55 is an elastic band, which has a central section spanning an opening of the receiving recess 54 and two ends fixedly mounted on two side walls of the receiving recess 54 of the speaker base 52. As a result, when the digital music player 60 is received in the receiving recess 54, the central section of the positioning element 55 will contact and abut against an outer surface of the digital music player 60, so that the digital music player 60 will be stably positioned in the receiving recess 54. It should be noted that the positioning element 55 can be selected from other equivalent mechanisms or fixtures except for the elastic band according to other alternative preferred embodiments of the present invention without limitation, so that other digital music player 60 of different specifications (i.e. size and dimension) also can be received in the receiving recess 54 and stably positioned in the receiving recess 54 by the positioning element 55 selected from the equivalent mechanisms or fixtures. Referring now to FIGS. 2 and 3, in the preferred embodiment of the present invention, the receiving recess 54 of the speaker base 52 has an inner bottom formed with a groove 521, while the speaker base 52 further includes an earphone connector 57 movably received in the groove 521. In other words, the earphone connector 57 can be independently rotated for adjusting a relative angle or direction thereof in relation to the groove 521 of the speaker base 52, while the earphone connector 57 can shift along the groove 521 for being aligned with various earphone jacks (not shown) of various digital music players 60 of different sizes and dimensions. As a result, the earphone connector 57 of the speaker base 52 can be easily connected to the earphone jack of the digital music player 60. Furthermore, the earphone connector 57 is electrically connected to a pair of speakers 523, 533 in the two speaker bases 52, 53 via a pair of signal cables 522. Therefore, the user can directly operate a control panel 62 of the digital music player 60, and monitor from a display panel 63 of the digital music player 60, so as to execute various control functions, such as selecting, playing, forward searching, backward searching, or stopping, to the voice files stored in the digital music player 60. After this, the analog voice signals generated by the digital music player 60 accordingly can be outputted to the two speakers 523, 533 via the earphone jack (not shown) so that the user can enjoy listening to the selected music form the earphone connector 57. As a result, the digital music player 60 of various specifications can be easily integrated into the hanging type wireless earphone 50 and directly positioned on the user's head without using any necklace auxiliary or additional signal cable, so that the user can completely enjoy listening to the music played by the digital music player 60. Consequently, the problem that the traditional digital music player is suspended on the user's neck by a necklace auxiliary and a signal cable resulting in impeding the normal motion of the user's body and causing inconvenience to the user can be efficiently solved. It should be noted that the groove 521 also can be formed on an inner surface of the two side walls of the receiving recess 54 except for the inner bottom of the receiving recess 54 according to actual needs of the user in other alternative preferred embodiments of the present invention without limitation, so that other digital music player 60 of different specifications (i.e. size and dimension) also can be received in the receiving recess 54 and stably positioned in the receiving recess 54, while the earphone connector 57 can shift along the groove 521 for adjusting a relative angle or direction thereof in relation to the groove 521 to be aligned with various earphone jack (not shown) of the digital music player 60 of different size and dimension, for the purpose of connecting the earphone connector 57 to the earphone jack of the digital music player 60.

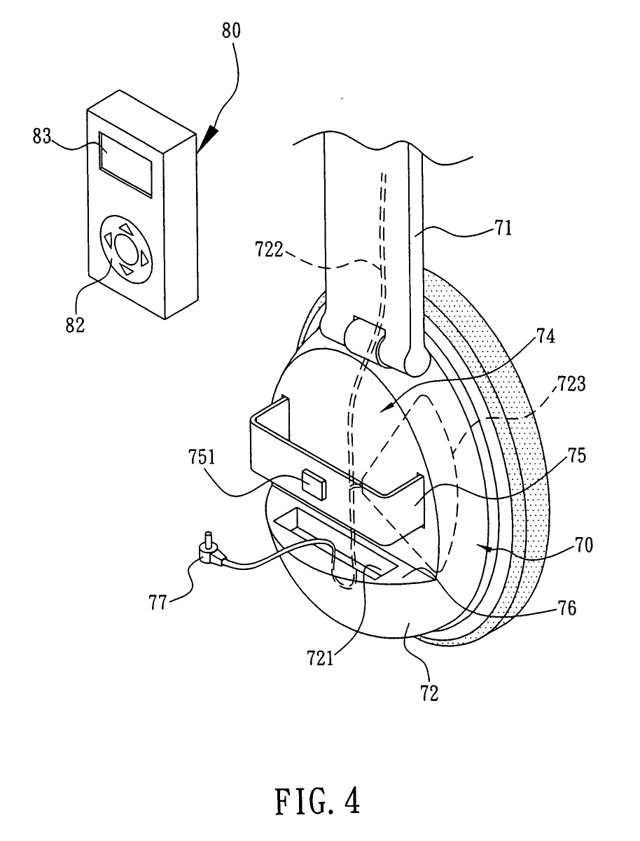

Referring now to FIG. 4, a hanging type wireless earphone for carrying a digital music player according to another preferred embodiment of the present invention is illustrated. As shown, the hanging type wireless earphone designated by numeral 70 comprises a hanging frame 71 and a pair of speaker bases 72, wherein each of the two speaker bases 72 is movably or fixedly mounted on either end of the hanging frame 71, respectively. When the hanging frame 71 is worn on a user's head, the two speaker bases 72 can be positioned and covered on the user's two ears, so that the user's ears can hear voice generated by the two speaker bases 72. In the preferred embodiment of the present invention as shown in FIG. 4, one of the two speaker bases 72 is provided with a receiving space 74 and a positioning fixture 75. The receiving space 74 has a dimension suitably used to receive a digital music player 80 of various specifications. The positioning fixture 75 is movably mounted on a portion of the speaker base 72 corresponding to the receiving space 74, and used to contact and abut against an outer surface of the digital music player 80, so that the digital music player 80 will be stably positioned in the receiving space 74 after the digital music player 80 is received in the receiving space 74. Preferably, the positioning fixture 75 is provided with a release button 751 thereon for releasing an abutment relationship between the positioning fixture 75 and the digital music player 80.

Referring to FIG. 4 again, in the preferred embodiment of the present invention, the receiving space 74 of the speaker base 72 has a bottom formed with a support 76 for supporting a bottom of the digital music player 80 when the digital music player 80 is received in the receiving space 74. The support 76 is formed with a groove 721, while the speaker base 72 further includes an earphone connector 77 movably received in the groove 721. In other words, the earphone connector 77 can be independently moved for adjusting a relative angle, direction, or position thereof in relation to the groove 721 of the speaker base 72 for being aligned with various earphone jacks (not shown) of various digital music players 80 of different sizes and dimensions. After the earphone connector 77 is suitably connected to the earphone jack of the digital music player 80, the digital music player 80 is received in the receiving space 74, and the bottom of the digital music player 80 is abutted against the support 76. Meanwhile, the earphone connector 77 is exactly received in the groove 721, and electrically connected to a pair of speakers 723 in the two speaker bases 72 via a pair of signal cables 722. Therefore, the digital music player 80 of various specifications can be easily integrated into the hanging type wireless earphone 70 and directly positioned on the user's head. Moreover, the user can directly control a control panel 82 of the digital music player 80, and monitor from a display panel 83 of the digital music player 80, so as to execute various control functions to voice files stored in the digital music player 80. After this, the analog voice signals generated by the digital music player 80 can be outputted to the two speakers 723 via the earphone jack (not shown) so that the user can enjoy listening to the selected music from the earphone connector 77 without using any necklace auxiliary or additional signal cable. Consequently, the problem that the traditional digital music player is suspended on the user's neck by a necklace auxiliary and a signal cable resulting in impeding the normal motion of the user's body and causing inconvenience to the user can be efficiently solved.

The present invention has been described with a preferred embodiment thereof and it is understood that many changes and modifications to the described embodiment can be carried out without departing from the scope and the spirit of the invention that is intended to be limited only by the appended claims.

What is claimed is:

1. A hanging type wireless earphone for carrying a digital music player, comprising:
a hanging frame; and
a pair of speaker bases movably or fixedly mounted on two ends of the hanging frame, wherein when the hanging frame is worn on a user's head, the two speaker bases are respectively positioned and covered on two ears of the user; one of the two speaker bases being provided with a receiving space and a positioning element, wherein the receiving space is used to receive the digital music player, and the positioning element is used to stably position the digital music player in the receiving space; the receiving space having a periphery provided with an earphone connector which has a direction and a position adjustable in relation to the receiving space, so that the earphone connector is electrically connected to an earphone jack of the digital music player; and wherein the earphone connector is further connected to a pair of speakers in the two speaker bases via a pair of signal cables.

2. The hanging type wireless earphone of claim 1, wherein the receiving space is a receiving recess having a dimension to receive the digital music player of various specifications.

3. The hanging type wireless earphone of claim 1, wherein the positioning element is an elastic band corresponding to the receiving space so that when the digital music player is received in the receiving space, a central section of the positioning element contacts and abuts against an outer surface of the digital music player.

4. The hanging type wireless earphone of claim 2, wherein the positioning element is an elastic band corresponding to the receiving space so that when the digital music player is received in the receiving space, a central section of the positioning element contacts and abuts against an outer surface of the digital music player.

5. The hanging type wireless earphone of claim 3, wherein the receiving space has an inner bottom formed with a groove, and the earphone connector is movably received in the groove; and wherein the earphone connector can be independently rotated for adjusting a relative angle or direction thereof in relation to the groove, and the earphone connector can be shifted along the groove.

6. The hanging type wireless earphone of claim 4, wherein the receiving space has an inner bottom formed with a groove, and the earphone connector is movably received in the groove; and wherein the earphone connector can be independently rotated for adjusting a relative angle or direction thereof in relation to the groove, and the earphone connector can be shifted along the groove.

7. The hanging type wireless earphone of claim 3, wherein the positioning element is a positioning fixture movably mounted on a portion of the speaker base corresponding to the receiving space, so as to contact and abut against an outer surface of the digital music player after the digital music player is received in the receiving space.

8. The hanging type wireless earphone of claim 4, wherein the positioning element is a positioning fixture movably mounted on a portion of the speaker base corresponding to the receiving space, so as to contact and abut against an outer surface of the digital music player after the digital music player is received in the receiving space.

9. The hanging type wireless earphone of claim 7, wherein the positioning fixture is provided with a release button thereon for releasing an abutment relationship between the positioning fixture and the digital music player.

10. The hanging type wireless earphone of claim 8, wherein the positioning fixture is provided with a release button thereon for releasing an abutment relationship between the positioning fixture and the digital music player.

11. The hanging type wireless earphone of claim 3, wherein the receiving space of the speaker base has a bottom formed with a support for supporting a bottom of the digital music player when the digital music player is received in the receiving space.

12. The hanging type wireless earphone of claim 4, wherein the receiving space of the speaker base has a bottom formed with a support for supporting a bottom of the digital music player when the digital music player is received in the receiving space.

13. The hanging type wireless earphone of claim 11, wherein the support is formed with a groove, and the earphone connector is movably received in the groove, so that the earphone connector can be independently moved for adjusting a relative angle, direction, or position thereof in relation to the groove.

14. The hanging type wireless earphone of claim 12, wherein the support is formed with a groove, and the earphone connector is movably received in the groove, so that the earphone connector can be independently moved for adjusting a relative angle, direction, or position thereof in relation to the groove.
